(19) United States
(12) Patent Application Publication
(10) Pub. No.: US 2023/0162056 A1
(43) Pub. Date: May 25, 2023

(54) SYSTEMS AND METHODS FOR INTERACTION-BASED INDICATIONS USING MACHINE LEARNING

(71) Applicant: Capital One Services, LLC, McLean, VA (US)

(72) Inventor: Thomas POOLE, Chantilly, VA (US)

(73) Assignee: Capital One Services, LLC, McLean, VA (US)

(21) Appl. No.: 17/456,383

(22) Filed: Nov. 24, 2021

(51) Int. Cl. G06N 5/04

(52) U.S. Cl. CPC G06N 5/04

(57) ABSTRACT

According to certain aspects of the disclosure, a computer-implemented method may be used for interaction-driven indications using machine learning. The method may include receiving information associated with previous interactions of a person and associating one or more items with a periodic event. Additionally, determining a likelihood of the person acquiring an item for a next occurrence of the periodic event and transmitting an indication to the person prior to the next occurrence of the periodic event. Additionally, based on interaction with the interactive text or graphics, causing a computing device of a person to navigate to an entity associated with the available items and receiving information related to the items. Additionally, causing display of an interactive interface indicative of at least one of the items, the information related to the one or more available items, or the periodic event.

### TECHNICAL FIELD

Various embodiments of the present disclosure relate generally to interaction-based indications using machine learning, and more specifically to artificial intelligence-based purchase reminders and/or recommendations using machine learning based on a user's purchase history and/or the preferences of a population.

### BACKGROUND

Consumers may wish to purchase event-related goods or services on a regular basis (e.g., annually, seasonally, or monthly) or on an otherwise time-specific schedule. For example, gift-giving during certain events is an important element in societies around the world, and consumers may purchase goods and/or services as gifts for a variety of reasons and occasions. Events for which goods or services are purchased may occur at, e.g., regular intervals (e.g., once a year), or may happen based on other timelines. It may be difficult or cumbersome for consumers to remember, or be aware of, all the events and occasions for which goods or services may be purchased. Additionally, it may be difficult or cumbersome for consumers to remember or remain aware of what they have previously purchased (e.g., specifically or generally) for such events and occasions. As a result, some consumers may not purchase goods or services for upcoming events and occasions, either out of forgetfulness or lack of time to search for appropriate purchases. In some cases, consumers may be unsure of what products to purchase for a given event.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, non-transitory computer readable media, systems, and methods are disclosed for interaction-based indications using machine learning. Each of the examples disclosed herein may include one or more of the features described in connection with any of the other disclosed examples. The systems and methods disclosed herein provide a technical solution to technical problems associated with interaction-based indications. Aspects of this disclosure will result in improved indications based on a person's prior interactions.

In one example, a computer-implemented method may be used for interaction-based indications using machine learning. The method may include receiving, by at least one processor, first data including information associated with previous interactions of a person; training, by the at least one processor, a machine learning model to associate one or more items identified from the information with a periodic event; receiving, by the at least one processor, from a machine learning model, a determination of the likelihood of the person acquiring an item for a next occurrence of the periodic event; upon determining that the likelihood is equal to or exceeds a predetermined likelihood threshold, transmitting, by the at least one processor, an indication to a computing device associated with the person prior to the next occurrence of the periodic event, wherein the indication is configured to cause a display of the computing device to display interactive text or graphics indicative of one or more available items associated with the periodic event; based on interaction with the interactive text or graphics by the person via the computing device, causing, by the at least one processor, the computing device to navigate to an entity associated with the one or more available items; receiving, by the at least one processor, second data including information related to the one or more available items; and causing the display of the computing device to display, by the at least one processor, an interactive interface indicative of at least one of the one or more items, the information related to the one or more available items, or the periodic event.

According to still another aspect of the disclosure, a computer system for interaction-based indications using machine learning may include a memory having processor-readable instructions stored therein and a processor configured to access the memory and execute the processor-readable instructions to perform a plurality of functions. The functions may include first data including information associated with previous interactions of a person; training a machine learning model to associate one or more items identified from the information with a periodic event; receiving, from the machine learning model, a likelihood of the person acquiring an item for a next occurrence of the periodic event; upon receiving a determination that the likelihood is equal to or exceeds a predetermined likelihood threshold, transmitting an indication to a computing device associated with the person prior to the next occurrence of the periodic event, wherein the indication is configured to cause a display of the computing device to display interactive text or graphics indicative of one or more available items associated with the periodic event; based on interaction with the interactive text or graphics by the person via the computing device, causing the computing device to navigate to an entity associated with the one or more available items; receiving second data including information related to the one or more available items by the user; and causing the display of the computing device to display an interactive interface indicative of at least one of the one or more items, the information related to the one or more available items, or the periodic event.

According to another aspect of the disclosure, a computer-implemented method may be used for interaction-based indications using machine learning. The method may include receiving, by at least one processor, first data including information associated with previous interactions of a person; parsing, by the at least one processor, one or more items based on the first data; training, by the at least one processor, a machine learning model to associate the one or more items identified from the first data with a periodic event; transmitting, by the at least one processor, an indication to a computing device associated with the person prior to a next occurrence of the periodic event, wherein the indication is configured to cause a display of the computing device to display interactive text or graphics indicative of one or more available items associated with the periodic event; based on interaction with the interactive text or graphics by the person via the computing device, causing, by the at least one processor, the computing device to navigate to an entity associated with the one or available items; receiving, by the at least one processor, second data including information related to the one or more available items; and receiving, by the at least one processor, an input from the person correlating the information related to the one or more available items with the periodic event.

In another embodiment, a computer-implemented method may be used for interaction-based indications using machine learning. The method may include receiving, by a processor, first data that includes information associated with previous interactions between a person and at least one entity; predicting, via a trained machine learning model executed by the processor and based on the first data, an event associated with the person, wherein the trained machine learning model is trained, based on (i) second data that includes information associated with previous interactions between one or more persons and one or more entities as test data, and (ii) third data that includes events corresponding to the previous interactions between the one or more persons and the one or more entities, to learn associations between one or more patterns in the previous interactions and the events corresponding to the previous interactions, such that the trained machine learning model is configured to determine an output event associated with the person in response to input data including information associated with previous interactions between the person and at least one entity; determining, based on the event associated with the person and the learned associations between the previous interactions of the one or more persons and the events, one or more items associated with the event associated with the person; obtaining fourth data that includes information associated the one or more items; and causing a display of a computing device associated with the person to display an interactive that includes a selectable indication of one or more of the event associated with the person or at least one of the one or more items, the selectable indication configured to cause the computing device to navigate to website page associated with an entity corresponding to the at least one of the one or more items in response to being selected.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems, methods, and other aspects of the present disclosure may be implemented.

FIGS. 2A and 2B depict exemplary flow charts of methods of generating interaction-driven indications, according to some embodiments.

FIGS. 3A-3C depict several views of an exemplary display for event reminders and product purchasing indications, according to one or more embodiments.

FIG. 4 depicts an exemplary computer device or system, in which embodiments of the present disclosure, or portions thereof, may be implemented.

### DETAILED DESCRIPTION

The subject matter of the present description will now be described more fully with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment is an “example” embodiment. Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Additionally, the phrase “in one embodiment” as used herein does not necessarily refer to the same embodiment throughout, and the phrase “in another embodiment” as used herein does not necessarily refer to a different embodiment. The phrase “in some embodiments” may refer to various embodiments having both shared and differing characteristics. It is intended, for example, that claimed subject matter may include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such herein. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

As described above, consumers may be faced with difficulties in remembering to purchase goods and services for upcoming events, as well as thinking of the goods and services to purchase for such events (e.g., gifts, supplies, planning tools, etc.). The present disclosure describes evaluating transaction data for patterns of event-related buying behavior. The evaluated data may be used to develop and/or trigger indications to the consumers to remind them about purchase opportunities preceding an upcoming event.

Furthermore, the indications may link a consumer to both their prior purchase history related to previous iterations of the event as well as provide the consumer with the ability to view available products and/or services from a merchant and/or to complete purchases with the merchant. Therefore, the present disclosure provides a technical solution to assist consumers and merchants by transmitting indication of events based on the purchase history of the consumers, and suggesting and/or directing consumers to merchants offering products and/or services to purchase for such events using machine learning. Further, the systems and methods of the present disclosure provide a technical solution for quickly generating accurate and relevant indications based on data related to a person's previous interactions.

As will be discussed in more detail below, in various embodiments, systems and methods are described for using machine learning for interaction based indications. For example, by training a machine-learning model, e.g., via supervised or semi-supervised learning, to learn associations between previous interactions data and periodic event data, the trained machine-learning model may be usable to associate one or more items with a periodic event.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Presented below are various aspects of machine learning techniques that may be adapted to associate one or more items from previous interactions of a person with the occurrence of a periodic event and/or determine the likelihood of the person acquiring an item for a next occurrence of the event. As will be discussed in more detail below, machine learning techniques adapted to associate one or more items from previous interactions of a person with the occurrence of a periodic event and/or determine the likelihood of the person acquiring an item for a next occurrence of the event, may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

In an exemplary use case, a trained machine learning model may be trained based on (i) training previous interactions of a person data that includes information regarding one or more previous interactions associated with the person and (ii) prior occurrence data that includes prior item information and information associated with prior events to learn relationships between the training previous interactions data and the prior occurrence data, such that the first trained machine learning model is configured to use the learned relationships to determine a likelihood of the person acquiring an item for a next occurrence of a periodic event data.

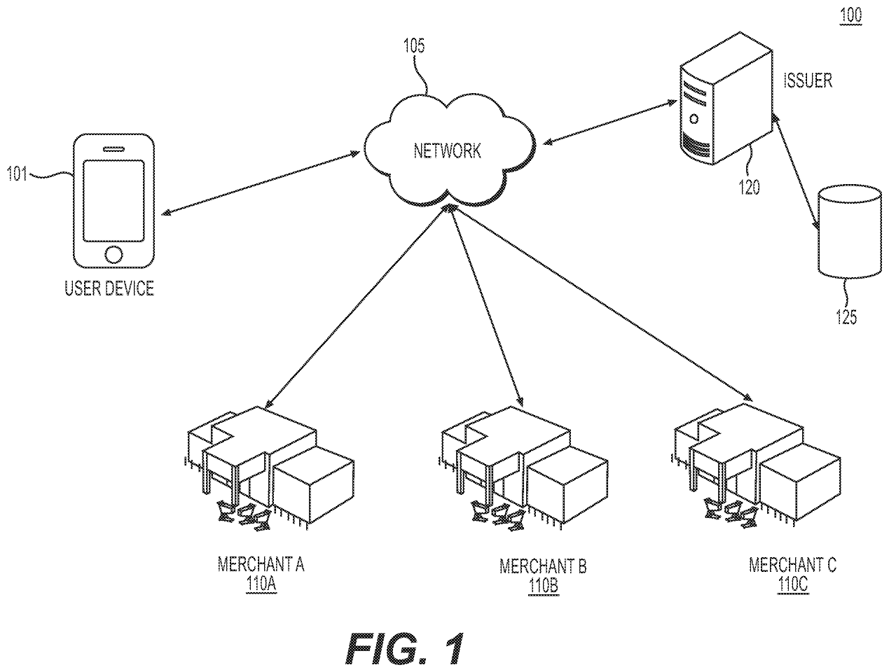

FIG. 1 depicts an exemplary environment in which systems, methods, and other aspects of the present disclosure may be implemented. The environment 100 may include a user device 101, a network 105, a plurality of merchants 110A-110C, an issuer 120, and a transaction database 125. The user device 101, the merchants 110A-110C, and the issuer 120 may communicate via the network 105. The network 105 may be any suitable wired or wireless network or combination of networks, and may support any appropriate protocol suitable for communication of data between various components in the environment 100. The network 105 may include a public network (e.g., the internet), a private network (e.g., a network within an organization), or a combination of public and/or private networks.

The user device 101 may be operated by one or more users (e.g., persons) to receive indications from and/or interact with the issuer 120, and/or perform purchases and transactions with the merchants 110A-110C. Examples of the user device 101 may include smartphones, wearable computing devices, tablet computers, laptops, and desktop computers. The user device 101 may have the ability to track information such as a user location, an application that the user is using, browser windows the user may be viewing, browser history, etc. The user device 101 may, with permission from the user, transmit some or all of such information to a processor belonging to the issuer 120 and/or the merchants 110A-110C.

Each of the plurality of merchants 110A-110C may be an entity that provides products (such as items). In this disclosure, the term “product,” in the context of products offered by a merchant, encompasses both goods and services, as well as combinations of goods and services. A merchant may be, for example, a retailer, wholesaler, distributor, lessor, or other type of entity that provides products or items that a user may purchase. A merchant may also, for example, operate one or more websites that may include virtual shopping carts that a user may access to conduct purchases.

The issuer 120 may be an entity such as a bank, a credit card issuer, a merchant services provider, or other type of financial service entity. In some examples, the issuer 120 may include one or more merchant services providers that provide merchants 110A-110C with the ability to accept electronic payments, such as payments using credit cards and debit cards. Therefore, the issuer 120 may collect and store transaction data pertaining to user transactions occurring at the merchants 110A-110C.

The transaction database 125 may include previous transaction data (e.g., previous interaction data) between merchants and users. “Previous transaction data” may include transactions that have been initiated, and that are either successful or unsuccessful. Successful transactions may be transactions that resulted in a purchaser completing a purchase. Unsuccessful transactions may be transactions that did not result in the purchaser completing the purchase. Unsuccessful transactions may include, for example, instances when a user views a product, or places a product in a virtual shopping cart, without subsequently completing the transaction. In some embodiments, the issuer 120 and/or the transaction database 125 may individually or in combination perform transaction analyses and algorithms required to run the methods of providing transaction-driven event reminders described herein.

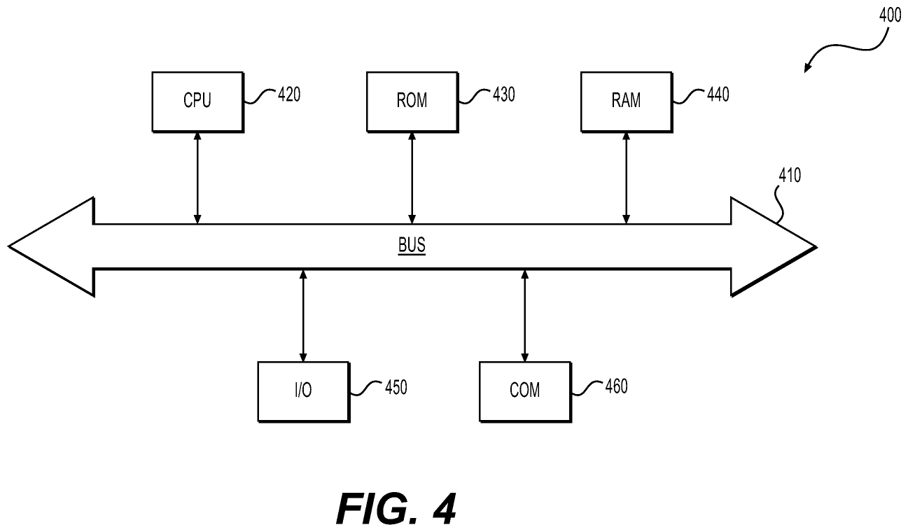

The environment 100 may include one or more computer systems configured to gather, process, transmit, and/or receive data. In general, whenever the environment 100 is described as performing an operation of gathering, processing, transmitting, or receiving data, it is understood that such operation may be performed by a computer system attributable to a component thereof, such as the issuer 120, the transaction database 125, the user device 101, and/or the one or more of merchants 110A, 1106, 110C. In general, a computer system may include one or more computing devices, as described in connection with FIG. 4 below.

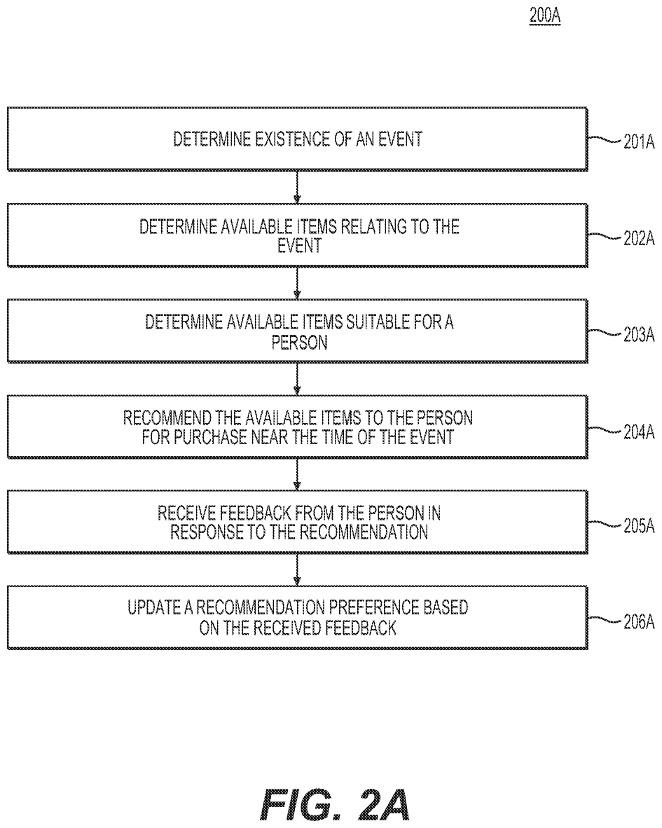

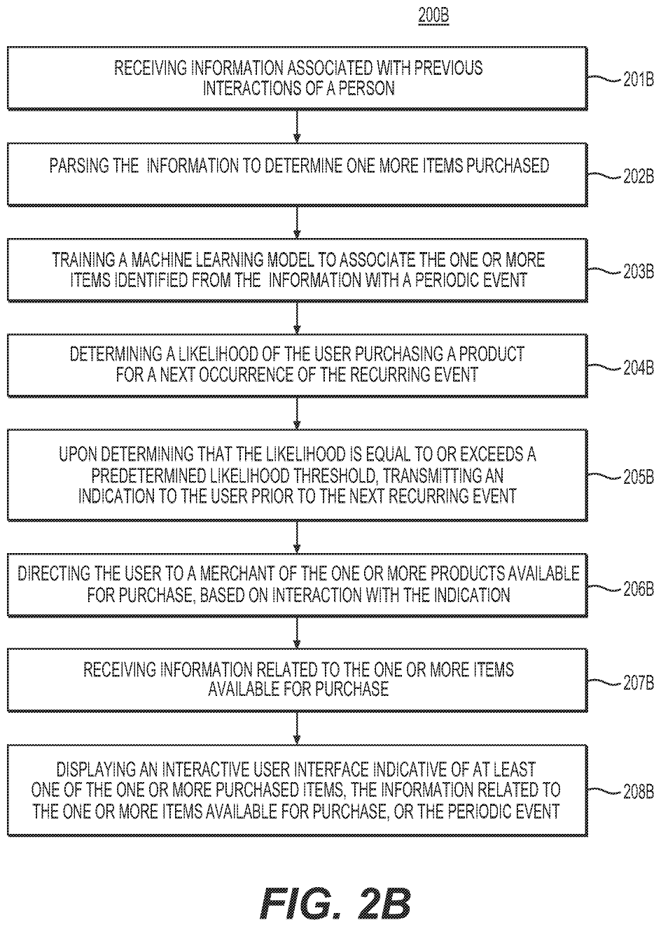

As discussed in further detail below, the issuer 120 may one or more of (i) generate, store, train, or use a machine-learning model configured to associate one or more items from previous interactions of a person with the occurrence of a periodic event and/or determine the likelihood of the person acquiring the item for a next occurrence of the event. The issuer 120 may include a machine-learning model and/or instructions associated with the machine-learning model, e.g., instructions for generating a machine-learning model, training the machine-learning model, using the machine-learning model etc. The issuer 120 may include instructions for retrieving previous interactions data, adjusting likelihood data, e.g., based on the output of the machine-learning model, and/or operating a display to output identified items data, e.g., as adjusted based on the machine-learning model. The issuer 120 may include training data, e.g., previous interactions data, and may include ground truth, e.g., periodic event or prior likelihood value data. Other types of data described with respect to FIGS. 1-2B may also be used as training data and/or ground truth data.

In some embodiments, a system or device other than issuer 120 is used to generate and/or train the machine-learning model, for example, transaction database 125 and/or the user device 101. For example, such a system may include instructions for generating the machine-learning model, the training data and ground truth, and/or instructions for training the machine-learning model. A resulting trained-machine-learning model may then be provided to the issuer 120.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between previous interactions data and periodic occurrence data, such that the trained machine-learning model is configured to determine an output one or more identified items in response to the input user data based on the learned associations.

Further aspects of the machine-learning model and/or how it may be utilized to associate one or more items identified with a periodic event are discussed in further detail in the methods below. In the following methods, various acts may be described as performed or executed by a component from FIG. 1, such as the issuer 120, the transaction database 125, the user device 101, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

FIG. 2A depicts a method of generating transaction-driven event reminders, according to one or more embodiments. Steps of the method 200A may be performed by, e.g., the issuer 120, in conjunction with the transaction database 125 and/or the user device 101. The method 200A may begin with step 201A where a determination is made as to the existence of an event. The determination may be made based on a number of different methods and/or data. For example, calendar entries of a user may be evaluated for the existence of events. Events that may appear on calendar entries may include, e.g., holidays, birthdays, anniversaries, meetings, vacations, trips, galas, conventions, concerts, etc. The existence of events may also be determined from current and/or historical purchases made by the user and/or other users. Historical purchases made by the user may be used to determine patterns that may indicate the existence of an event. For example, the user may have made purchases on or around the same time every year (e.g., an annual purchase of jewelry, perfume, travel tickets, a vacation rental, etc.), therefore indicating the existence of an event. Purchases made by the user and/or other users may be used to indicate the existence of an event. For example, if many users make an increased number of a certain type of purchase on or around the same time, the increase in purchases made may be an indication of the existence of an event. In some embodiments, it is contemplated that a machine learning model may be used to identify the existence of one or more events, e.g., based on data related to user purchase patterns made available to the machine learning model. For example, a machine learning model may be trained to recognize the existence of events using a quantity of purchase data from users, optionally along with a list of events. In such embodiments, any suitable machine learning model may be used, such as a random forest model, a decision tree, a linear regression model, a Naive Bayes model, or the like.

At step 202A, a determination is made of available products potentially relating to the event. The products determined to be available and relevant may be based on the current and/or historical purchases made by the user and/or other users. For example, the determined available products may be similar products to, or the same products as, those purchased by the user and other users. For example, cakes may be regularly purchased for events such as a birthday or an anniversary, and may be determined to be relevant to such events. Products similar to cakes (e.g., cookies or cupcakes) may also be determined to be relevant to such events. Availability of products relating to an event may be determined based on whether one or more merchants is offering such products for purchase. For example, an entity performing the step 202A (e.g., an issuer 120) may access an inventory of a merchant (e.g., merchants 110A-110C) to determine whether products relevant to an event are stocked in the merchant's inventory. For this purpose, the issuer 120 may be granted access to a non-public inventory of a merchant, or may access a publicly-available inventory, such as via an online storefront.

At step 203A, from all the available products related to the event, a determination is made of products that are suitable for a user. Products may be deemed suitable for the user based on a profile of a person, e.g., the purchase history of the user, demographic information of the user, and/or on the preferences of the user. For example, if the user has made previous purchases of products in relation to an event, then the same or similar products may be deemed suitable for the user to purchase. Additionally, demographic information of the user may be used to determine suitability of products for the user. For example, an age range, income level, and/or geographic location of the user may determine the suitability of products for the user to purchase. Furthermore, the user may set up preferences on what products to purchase (e.g., by product type or product category), by inputting one or more preferences on, e.g., an application user interface on the user device 101. Such preferences may include, e.g., a price range, a shipping speed, a geographic location, a merchant type, a product category (e.g., food, luxury products, experiences, etc.). Such preferences may be made available to an entity determining suitable products for the user (e.g., the issuer 120). Products matching the preferences may be deemed suitable for the user to purchase. These preferences and other information may be recorded and stored as a profile for the user or person, which in some embodiments may further be updated by a user.

At step 204A, the suitable products may be recommended to the user for purchase near the time of the event. The recommendation may be sent as, e.g., an email, a text message, an indication and/or graphics on the user device 101, a listing on an application user interface on the user device 101, or by any other suitable means. A determination of what constitutes “near the time of the event” may be based on, e.g., a pre-set time (such as one month, two weeks, one week, three days, or any suitable pre-set time), user preference, a time required for a product to be shipped to a destination after purchase, and/or prior user purchase patterns. For example, if prior user purchase patterns indicate that consumers purchase flowers three days in advance of Valentine's Day, then flowers may be recommended to the user for purchase four or five days in advance of Valentine's Day. In some embodiments, the user device 101 may automatically navigate a browser to a webpage of an entity associated with the one or more available items, for example, a flower shop that is able to execute a delivery or make flowers available for pickup before the periodic event (e.g., Valentine's day).

At step 205A, feedback may be received from the user in response to the recommendation. The user may purchase the products based on the recommendation, in which case a positive feedback may be associated with the recommendation. Alternatively, the user may not make any purchases, and therefore a negative feedback may be associated with the recommendation. In another embodiment, the user may proactively indicate a positive or negative reaction to the products purchased (e.g., by submitting a response to the recommending entity via an application on the user device 101). In yet another embodiment, the user may indicate to not receive any further recommendations for an event or during a particular time period. In step 206A, the received feedback may be used to update recommendation preferences attributable to the user. For example, a positive feedback may cause the issuer 120 to update a recommendation preference to recommend the same or similar products at the next occurrence of the event. Alternatively, a negative feedback may prompt the issuer 120 to update the recommendation preference such that it does not recommend the same or similar products, or such that it recommends an alternative product at the next occurrence of the event. In some embodiments, an input from the person correlating the information related to the one or more available items with the periodic event may be received. For example, a user may expressly indicate that a suggested one or more available items is actually correlated with the periodic event.

FIG. 2B depicts a flow chart of an exemplary method 200B of generating event-related reminders and product recommendations, according to one or more embodiments. The method 200B may begin with step 201B, where data including information associated with previous interactions of a person (for example, an account of a user) is received, e.g., from the user or from a merchant. The previous interactions of a user may be an account of the user such as an account of a financial instrument (e.g., a credit card) issued by the issuer 120, and used by the user to make purchases. Data related to other accounts or interactions of the user may be received as well, if the user provides permission for the issuer 120 to access those accounts or interactions. In some embodiments, a web browser plugin may be installed by the user on a user device (e.g., the user device 101) and the plugin may monitor and retrieve the transaction behavior of the user. The issuer 120 may also or alternatively form agreements with merchants 110A-110C to supply the issuer 120 with a record of goods or services purchased by users (e.g., an anonymized record, or a record including user information with the permission of one or more users) as part of the transaction information associated with an account of a user.

At step 202B, the transaction information may be parsed to determine one or more products purchased. The parsing process may be completed by one or more of a plurality of methods. For example, a web browser plugin installed by the user on, e.g., the user device 101 may not only retrieve transaction behavior of the user, but may also analyze the transaction behavior and determine the goods or services purchased by the user. In addition to determining one or more products purchased, the step 202B of parsing transaction information may also include determining information such as timing of a purchase, a price of one or more purchased products, location of the merchants from which products were purchased, location of the user at the time of purchase, a quantity of one or more products purchased, shipping speed selected by the user for the one or more products purchased, or any other relevant information. In some embodiments, machine learning may be utilized to determine one or more products purchased from received transaction information. A machine learning algorithm or model (e.g., a tree searching algorithm, a random forest model, or the like) may evaluate transaction information and identify data included in it, such as merchant name and a merchant category to which the merchant belongs, to determine the products purchased by the user. The machine learning algorithm may be trained by, e.g., receiving input data regarding merchant identities (e.g., merchant names, store numbers, etc.) and products sold by such merchants. Once trained, the machine learning algorithm may be periodically tuned using purchasing information indicating a merchant name (or other means of identifying a merchant) and products purchased from the merchant.

Upon determining the one or more products purchased, at step 203B the purchased products identified from the transaction information may be associated with a recurring or periodic event. This may be done by, e.g., identifying an event, as described elsewhere herein (see, e.g., step 201A), and associating purchased products with an identified event. Associating purchased products with an identified event may include, e.g., relating products purchased to an event that occurs shortly after a purchase, and/or receiving another indication that a product purchased is tied to an event (e.g., receiving an indication that a product is part of a holiday sale or is a part of a merchant inventory stocked for a particular holiday, or receiving an indication from a user or a merchant that a product was purchased for a gift). For example, a browser extension may be used to extract information from relevant fields displayed on a browser (e.g., gift receipt field, personalized message field, physical address, e-mail address, and so forth) pertaining to the event described above. In additional embodiments, an application may scan a user's electronic message or mail and extract information as explained above pertaining to the event. While browser extensions and applications are described above, other software or tools may be used to scan for and extract information pertaining to the event. While methods and systems above and below are described for determining likely events, the same principles may be applied to determining a likely gift recipient. In this manner, purchased items may be associated with a likely event and a likely recipient, for example, a likely recipient may be determined, and likely events pertaining to the likely recipient may be determined.

At step 204B, a likelihood of the user purchasing a product for a next occurrence of the recurring or periodic event may be determined. The likelihood may depend on a number of factors, such as purchase history, products purchased, user feedback, significance of the event, etc. For example, if the user has purchased goods or services for several occurrences of the recurring or periodic event, then the likelihood of the user making a purchase for the next occurrence of the recurring or periodic event may be high. If the user indicates that a transaction or the specific goods or services purchased may not have been satisfactory, and/or that the event was not of significance to the user, then the likelihood of the user making a purchase for the next occurrence of the recurring or periodic event may be low. In some embodiments, a likelihood may be represented by a numerical value, such as a percentage value.

At step 205B, upon determining that the likelihood is equal to or exceeds a predetermined likelihood threshold, an indication to the user may be transmitted prior to the next recurrence of the event. The predetermined likelihood threshold may be determined by the issuer 120 or may be set by the user, and may also be set and/or adjustable by the issuer 120, the user, and/or the machine learning algorithm. The step of transmitting the indication may also include determining products available for purchase (see, e.g., step 202A and step 203A). Additionally, step 205B may share one or more characteristics with step 204A. For example, transmitting the indication may take into account availability of products for purchase and/or time it may take for the user or a recipient to receive a purchased product. For example, if a product has low availability or is a highly desirable product, the indication may be transmitted to the user with ample time for the user to make the purchase, taking into consideration that the product may sell out. Similarly, if the product is estimated to take a certain amount of time to arrive to the user or recipient, then the indication may be transmitted to the user before the next recurring event based on the amount of time it would take for the product to arrive after being purchased. At step 206B, based on the user interaction with the indication, the user may be directed to a merchant with the one or more products available for purchase (e.g., a merchant with an online storefront, or a merchant within a geographic proximity of the user). At step 207B, information related to the one or more products available for purchase may be received by the user. Information related to the one or more products available for purchase may include the price of the product(s), an image or images of the product(s), ratings associated with the product(s), delivery time, stock level, payment information, etc. The information related to the one or more products may assist the user in determining whether to complete the purchase of the one or more products. At step 208B, an interactive user interface may be displayed to the user, e.g., on the user device 101, which may indicate at least one of the one or more purchased products, the information related to the one or more products available for purchase, or the recurring or periodic event. The interactive user interface may be configured to allow the user to view (either automatically or by user selection) a confirmation of the one or more products purchased, and/or more information regarding the recurring or periodic event, and/or any other products associated with the event that are available for purchase.

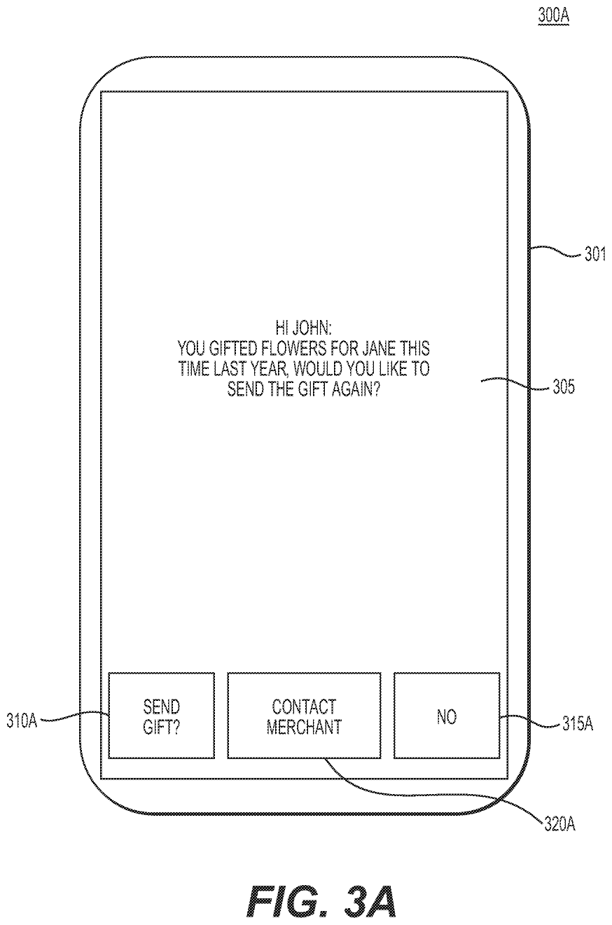

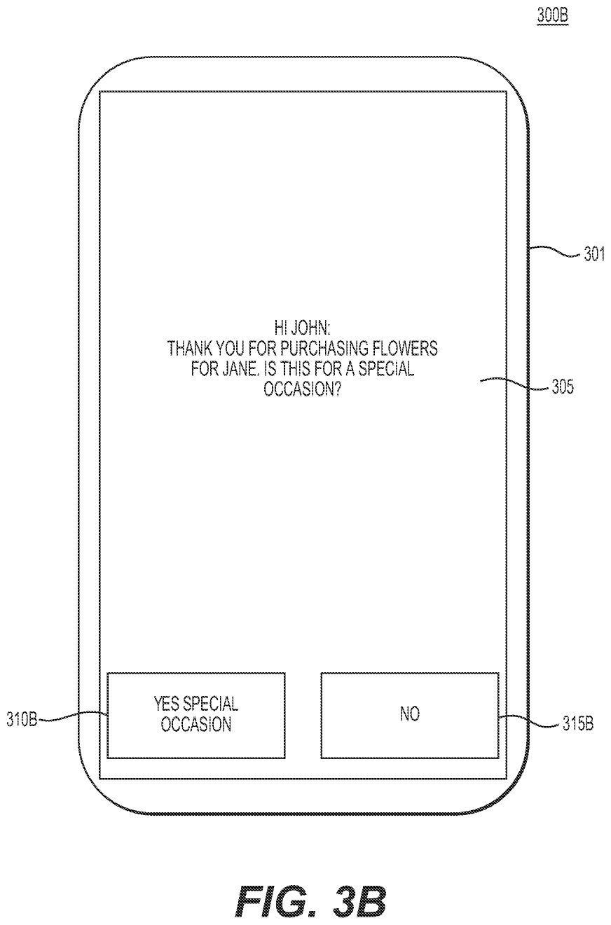

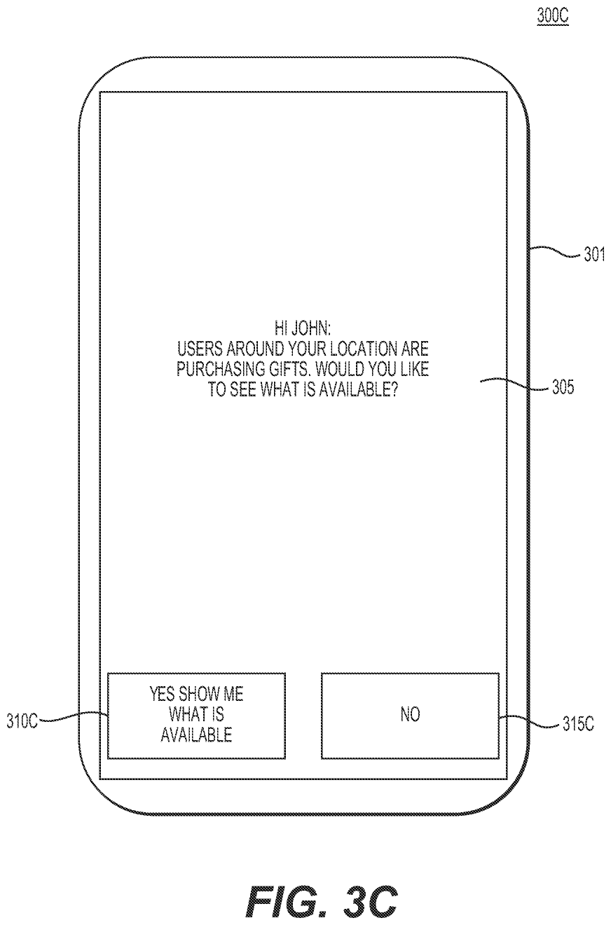

FIGS. 3A-3C depict exemplary displays 300A-300C of a user interface for event reminders and product purchasing, according to one or more embodiments. Displays 300A-300C may be, for example, views of a user interface for use on a user device involved in methods disclosed herein (e.g., method 200A and method 200B).

The display 300A may, e.g., show an indication to a user for event reminder, and may be displayed on a user device 301. The user device 301 may correspond to the user device 101 depicted in FIG. 1. The display 300A may include an indication display area 305, and the response options 310A, 315A and 320A. The response options 310A, 315A and 320A may correspond to physical hardware buttons on the user device 301, or may be digitally-displayed touch-sensitive buttons displayed on the user device 301.

The display 300A may represent one embodiment of a transaction-driven event reminder. The indication display area 305 may display an indication to the user that an event which the user has purchased goods or services previously is approaching and may further assist the user to purchase goods or services. The indication display area 305 may display a plurality of different indications. For example, it may notify the user to send a gift that was sent previously, or send a similar gift as one that was sent previously, or view a list of current deals on similar types of gifts. The indication may be sent by the issuer 120 or by one of the merchants 110A-110C via the network 105. The indication may be sent as a part of any method disclosed herein, such as method 200A or method 200B. For example, the issuer 120 may have access to transaction data of the user to use as a trigger for pushing an indication of a purchasing opportunity. For example, the issuer 120 may be an issuer of a financial instrument and the user may use the financial instrument to purchase goods and services. The issuer 120 may utilize several different methods of evaluating transaction data to determine clear patterns of event-related purchase behavior. For example, the issuer 120 may maintain a list of well-known holidays (including, e.g., Valentine's Day, Christmas, Halloween, Thanksgiving, Hanukkah, Memorial Day, Diwali, New Year's Day, etc.) and evaluate transaction behavior surrounding those days for evidence of specific purchases linked to the holidays. If the issuer 120 identifies purchases linked to those dates (e.g., users purchase flowers a week before Valentine's Day), then the issuer 120 may trigger an indication to be sent to a user before the next occurrence of Valentine's Day to suggest that the user purchase flowers or other appropriate products. As described with respect to methods 200A and 200B, the issuer 120 may also identify purchases made on a periodic basis, such as large number of gifts and/or luxury products at times not associated with any well-known events. The issuer 120 may infer that those purchases are related to an event, such as a birthday or anniversary.

In some embodiments, machine learning may be utilized to evaluate and predict purchases connected to events. Machine learning algorithms such as tree searching algorithms, convolutional neural networks (CNN), or any other machine learning algorithm disclosed herein or elsewhere may be employed. As described elsewhere herein, machine learning algorithms may be trained with transaction data and purchase dates to establish known gift giving events. Such machine learning algorithms may be located at, e.g., a processor under the ownership, operation, or management of the issuer 120, or may be located in the transaction database 125, or may be located in any suitable location or plurality of locations. The machine learning algorithms may then be applied to transaction data of a user to determine transactions and events related to the user. The linked transactions and events may be stored in, e.g., the transaction database 125 and may be used to trigger indications to one or more users before the next occurrence of one or more events identified as being relevant to the one or more users. The machine learning algorithms may be tuned after training by receiving feedback, such as user feedback received after completion of transactions (e.g., purchases). The machine learning algorithms may also be tuned, for example, to filter out certain products or events based on negative user feedback (e.g., an indication of no relationship between a purchase and an event, a desire for fewer indications, or the like). The neural network may further used to generate and display information to the user on a display. For example, the neural network may transmit information to the user in the form of natural language statements in order to, for example, imitate human speech. The natural language statements may further be customized based on user information received, transaction data, purchase information, feedback, and so forth.

Upon receiving the indication displayed in the indication display area 305, the user may use one of the response options 310A, 315A and/or 320A to respond to the indications. For example, as depicted on the display 300A, the issuer 120 sends an indication to the user informing the user that based on prior purchases, a purchase-linked event is approaching, and may inquire whether the user wants to purchase flowers again. The user may respond in the affirmative and select the option 310A to purchase flowers again. Or, the user may select the option 320A to contact the merchant, or may select response option 315A to respond in the negative to indicate that the user does not have a desire to make the purchase. Selecting the option 320A may allow the user device to automatically initiate a phone call with merchant, or may allow the user to view the merchant's website. The user may interact with the merchant or the website to determine available goods or services for purchase and may finalize the purchase with the merchant.

In another embodiment, the user may interact with the indication to connect with the merchant or view more information. For example, the user may interact with the indication (e.g., click with a mouse or a touch gesture) in the indication display area 305 and a purchase history may be displayed to the user to show the user prior purchases made for the event. Alternatively, upon interacting with the indication, a number of merchants with the available goods or services may be displayed to the user. For example, upon interacting with the indication, a list of florists may be displayed to the user for the user to select to purchase flowers from. In addition, a list of alternative goods or services may also be displayed to the user. For example, instead of displaying to the user available flowers to purchase, chocolates and/or stuffed animals may be displayed to the user for purchase.

FIG. 3B depicts an exemplary display for event reminders and product purchasing, according to one or more embodiments. The display 300B may depict an exemplary user interface for the user to indicate that a purchase is associated with an event and may be displayed on a user device 301. The user device 301 may correspond to the user device 101 depicted in FIG. 1. The display 300B may include an indication display area 305, and the response options 310B and 315B. The response options 310B and 315B may correspond to physical hardware buttons on the user device 301 or may be software buttons displayed on the user device 301.

Upon a user making a purchase, the issuer 120 may request additional information from the user. For example, the issuer 120 may ask the user if the purchase is associated with an event, as displayed in the indication display area 305. The user may respond by interacting with either of the response options 310B and 315B. If the user responds with the response option 315B in the negative, the issuer 120 may make the determination that there is no association between the purchase and an event, and no further action is needed. If the user responds with the response option 310B in the affirmative (e.g., the purchase is associated with an event), the issuer 120 may store the date and the goods or services purchased in the transaction database 125. The issuer 120 may then use the response from the user as a trigger for a purchase reminder for the next occurrence of the event. The responses received from the user may also be used to further tune the machine learning algorithms to improve the algorithm's efficiency in associating purchases with events. As explained above, the request for additional information from a user may be generated by a machine learning algorithm, and may be made in the form of natural language statements presented on a display screen.

If the user responds with the response option 3106 in the affirmative, the issuer 120 may also ask the user for the type or category of the event. For example, the issuer 120 may display on the indication display area 305 a list of common events (e.g., birthdate, anniversary, holiday, etc.) for the user to select from. The user may also be able to enter a custom event into the user device 101. The custom event may include information regarding the frequency of the event, product categories related to the event, a recipient or recipients of any purchases related to the event, and/or other relevant information. The issuer 120 may also ask the user if the user would like to be reminded for the next occurrence of the event. If the user responds in the affirmative then the issuer 120 may save the user preference and remind the user before the next occurrence of the event. If the user responds in the negative, then the issuer 120 may save the user preference and will not remind the user of the next occurrence of the event.

FIG. 3C depicts an exemplary display for event reminders and product purchasing, according to one or more embodiments. The display 300C may depict an exemplary user interface for the user to be reminded of a transaction-driven event purchasing opportunity, and may be displayed on a user device 301. The user device 301 may correspond to the user device 101 depicted in FIG. 1. The display 300C may include an indication display area 305, and response options 310C and 315C. The response options 310C and 315C may be physical hardware buttons on the user device 301 or may be software-generated buttons displayed on the user device 301.

In the embodiment depicted by FIG. 3C, the issuer 120 may trigger an indication to the user regarding a purchase opportunity based on purchases from other users, and may display the indication via the display 300C. The Issuer 120 may receive transaction information from a plurality of users, and may evaluate the transaction information to determine data such as the date, time, location, merchant, and goods or services purchased by all users. The issuer 120 may parse through the determined data to identify any clear patterns of event buying behavior. For example, the issuer 120 may notice an increase in flowers purchased by all the users within a period of time, and therefore the issuer 120 may conclude that the flower purchases are related to an event. The transaction information from the plurality of users evaluated by the issuer 120 may be filtered by, e.g., demographic information of the user. Demographic information of the user may include, e.g., a location of the user, an age of the user, a financial status of the user, and/or other relevant information. Examples of filtering by demographic information of the user may include filtering transaction information from other users to only include those transactions by users who are located within a predetermined geographic location from the user. Filtering by geographic location may prevent purchase indication being triggered by events in other geographic locations that may not exist or may not be a significant purchasing opportunity in the geographic location of the user. Other filters may also be applied to the transaction information from the plurality of users. For example, filters may be applied to limit products to a predetermined price, or filters may be applied to limit to predetermined product categories, or filters may be applied based on the shipping time of the products.

Upon determining that an event exists, the issuer 120 may trigger an indication to the user device 101 to notify the user of the purchase opportunity. For example, the indication displayed in the indication display area 305 may indicate to the user that other users are making purchases and inquire if the user would also like to make a purchase. The user may respond with one of the response options 310C and 315C.

If the user respond with the response option 310C, the indication display area 305 may show the user goods or services purchased by the other users, that the user is able to purchase if desired. The user may select at least one of the goods or services and finalize the purchase. The indication display area 305 may also display to the user a list of merchants the other users are purchasing from. The user may select a merchant to view the available goods or services and finalize the purchase. If the user respond with the response option 315C, then this may serve as an indication that no purchases are desired.

FIG. 4 depicts a high-level functional block diagram of an exemplary computer device or system, in which embodiments of the present disclosure, or portions thereof, may be implemented, e.g., as computer-readable code. Additionally, each of the exemplary computer servers, databases, user interfaces, modules, and methods described above with respect to FIGS. 1-3C can be implemented in the device 400 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-3C.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-3C, may be implemented using the device 400. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 4, the device 400 may include a central processing unit (CPU) 420. The CPU 420 may be any type of processor device including, for example, any type of special purpose or a general-purpose microprocessor device. As will be appreciated by persons skilled in the relevant art, the CPU 420 also may be a single processor in a multi-core/multiprocessor system, such system operating alone, or in a cluster of computing devices operating in a cluster or server farm. The CPU 420 may be connected to a data communication infrastructure 410, for example, a bus, message queue, network, or multi-core message-passing scheme.

The device 400 also may include a main memory 440, for example, random access memory (RAM), and also may include a secondary memory 430. The secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, the secondary memory 430 may include other similar means for allowing computer programs or other instructions to be loaded into the device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to the device 400.

The device 400 also may include a communications interface (“COM”) 460. The communications interface 460 allows software and data to be transferred between the device 400 and external devices. The communications interface 460 may include a modem, a network interface (such as an Ethernet card), a communications port, a PCMCIA slot and card, or the like. Software and data transferred via the communications interface 460 may be in the form of signals, which may be electronic, electromagnetic, optical, or other signals capable of being received by the communications interface 460. These signals may be provided to the communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. The device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for interaction-based indications using machine learning, the method comprising:
receiving, by at least one processor, first data including information associated with previous interactions of a person;
training, by the at least one processor, a machine learning model to associate one or more items identified from the information with a periodic event;
receiving, by the at least one processor, from the machine learning model, a determination of a likelihood of the person acquiring an item for a next occurrence of the periodic event;
upon receiving a determination that the likelihood is equal to or exceeds a predetermined likelihood threshold, transmitting, by the at least one processor, an indication to a computing device associated with the person prior to the next occurrence of the periodic event, wherein the indication is configured to cause a display of the computing device to display interactive text or graphics indicative of one or more available items associated with the periodic event;
based on interaction with the interactive text or graphics by the person via the computing device, causing, by the at least one processor, the computing device to navigate to an entity associated with the one or more available items;
receiving, by the at least one processor, second data including information related to the one or more available items; and
causing the display of the computing device to display, by the at least one processor, an interactive interface indicative of at least one of the one or more items, the information related to the one or more available items, or the periodic event.

2. The computer-implemented method of claim 1, further including receiving, by the at least one processor, an input from the person correlating the information related to the one or more available items with the periodic event.

3. The computer-implemented method of claim 1, further including generating, by the at least one processor, a profile of the person, wherein the profile includes at least one of the information associated with the previous interactions of the person, demographic information, or preference information.

4. The computer-implemented method of claim 3, further including adjusting, by the at least one processor, the one or more available items based on the profile of the person.

5. The computer-implemented method of claim 3, further including adjusting, by the at least one processor, the indication to the computing device associated with the person based on the profile of the person.

6. The computer-implemented method of claim 1, further including receiving, by the at least one processor, a feedback from the person related to the one or more items.

7. The computer-implemented method of claim 6, wherein the determination of the likelihood of the person acquiring the item for the next occurrence of the periodic event is further based on the feedback from the person.

8. The computer-implemented method of claim 1, further including training, by the at least one processor, the machine learning model to associate one or more items identified from additional information of the person.

9. The computer-implemented method of claim 8, wherein the indication to the computing device associated with the person prior to the next occurrence of the periodic event is based on the additional information of the person.

10. The computer-implemented method of claim 1, wherein the causing the display of the computing device to display an interactive user interface indicative of at least one of the one or more items, the information related to the one or more available items, or the periodic event further comprises displaying natural language statements generated by the machine learning model based on the one or more items, the information related to the one or more available items by the person, or the periodic event.

11. A computer system for interaction-based indications using machine learning, the computer system comprising:
at least one memory having processor-readable instructions stored therein; and
at least one processor configured to access the memory and execute the processor-readable instructions, which when executed by the processor configures the processor to perform a plurality of functions, including functions for:
receiving first data including information associated with previous interactions of a person;
training a machine learning model to associate one or more items identified from the information with a periodic event;
receiving, from the machine learning model, a likelihood of the person acquiring an item for a next occurrence of the periodic event;
upon receiving a determination that the likelihood is equal to or exceeds a predetermined likelihood threshold, transmitting an indication to a computing device associated with the person prior to the next occurrence of the periodic event, wherein the indication is configured to cause a display of the computing device to display interactive text or graphics indicative of one or more available items associated with the periodic event;
based on interaction with the interactive text or graphics by the person via the computing device, causing the computing device to navigate to an entity associated with the one or more available items;
receiving second data including information related to the one or more available items by the person; and
causing the display of the computing device to display an interactive interface indicative of at least one of the one or more items, the information related to the one or more available items, or the periodic event.

12. The computer system of claim 11, wherein the functions further include:
receiving an input from the person correlating the information related to the one or more available items with the periodic event.

13. The computer system of claim 11, wherein the functions further include:
generating a profile of the person, wherein the profile includes at least one of the information associated with the previous interactions of the person, demographic information, or preference information.

14. The computer system of claim 13, wherein the functions further include:
adjusting the one or more available items based on the profile of the person.

15. The computer system of claim 13, wherein the functions further include:
adjusting the indication to the computing device associated with the person based on the profile of the person.

16. The computer system of claim 11, wherein the functions further include:
receiving a feedback from the person related to the one or more items.

17. The computer system of claim 16, wherein the function of determining the likelihood of the person acquiring the item for the next occurrence of the periodic event is further based on the feedback from the person.

18. The computer system of claim 11, wherein the functions further include:
training the machine learning model to associate one or more items identified from additional information of the person.

19. The computer system of claim 18, wherein the indication to the computing device associated with the person prior to the next occurrence of the periodic event is based on the additional information of the person.

20. A computer-implemented method for interaction-based indications using machine learning, the method comprising:
receiving, by at least one processor, first data including information associated with previous interactions of a person;
parsing, by the at least one processor, one or more items based on the first data;
training, by the at least one processor, a machine learning model to associate the one or more items identified from the first data with a periodic event;
transmitting, by the at least one processor, an indication to a computing device associated with the person prior to a next occurrence of the periodic event, wherein the indication is configured to cause a display of the computing device to display interactive text or graphics indicative of one or more available items associated with the periodic event;
based on interaction with the interactive text or graphics by the person via the computing device, causing, by the at least one processor, the computing device to navigate to an entity associated with the one or available items;
receiving, by the at least one processor, second data including information related to the one or more available items; and
receiving, by the at least one processor, an input from the person correlating the information related to the one or more available items with the periodic event.
